(19) United States
(12) Patent Application Publication
(10) Pub. No.: US 2010/0143606 A1
(43) Pub. Date: Jun. 10, 2010

(54) Photocation-Curable Ink and Ink-Jet Recording Method by Using Photocation-Curable Ink

(75) Inventors: Akiko NOGUCHI, Kasugai-shi (JP); Yuki MIURA, Toyoake-shi, Aichi-ken (JP); Atsushi NARUSE, Okazaki-shi, Aichi-ken (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/631,196

(22) Filed: Dec. 4, 2009

(30) Foreign Application Priority Data
Dec. 5, 2008 (JP) 2008-310787

(51) Int. Cl. B05D 3/06; C08K 5/3435

(52) U.S. Cl. 427/511; 522/75

(57) ABSTRACT

The present invention is directed to a photocation-curable ink, an object of which is to improve the adhesion performance with respect to a recording medium without deteriorating the hardness of an ink coating film irrelevant to the type of a photopolymerization initiator. The photocation-curable ink according to the present invention uses a 2,2,6,6-tetramethylpiperidine 1-oxyl free radical or a compound including a 2,2,6,6-tetramethylpiperidine 1-oxyl free radical structure; wherein molar concentration of the 2,2,6,6-tetramethylpiperidine 1-oxyl free radical or the 2,2,6,6-tetramethylpiperidine 1-oxyl free radical structure in the ink is 19.6 mM to 39.2 mM. Accordingly, it is possible to obtain the photocation-curable ink having the high adhesion performance with respect to the printing medium.

### CROSS REFERENCE TO RELATED APPLICATION

The present application claims priority from Japanese Paten Application No. 2008-310787, filed on Dec. 5, 2008, the disclosure of which is incorporated herein by reference in its entirety.

### BACKGROUND OF THE INVENTION

1. Field of the Invention

The present invention relates to a photocation-curable ink which is curable by the active energy beam.

2. Description of the Related Art

The photocurable ink, which is cured by radiation of the light or the active energy beam such as the ultraviolet light, is required to have the sufficient adhesion performance with respect to the printing medium after the curing. If the adhesion performance is insufficient, the cured ink tends to be exfoliated from the printing medium with ease, which causes the easy disappearance of the formed matter including, for example, letters and pictures formed on the printing medium, especially due to any external factor including, for example, the friction.

It is known that the reaction of the curing of the photocurable ink includes those based on the radical polymerization and those based on the cationic polymerization. In general, it is known that the photocurable ink (hereinafter referred to as “photocation-curable ink”), which utilizes the cationic polymerization, is excellent in the adhesion performance with respect to the printing medium as compared with the photocurable ink which utilizes the radical polymerization, which may provide a solution for the problem as described above.

The photopolymerization initiator is generally added as an additive to start the polymerization to the photocation-curable ink. The selection thereof differs depending on, for example, the reason of the enhancement of the hardness. However, the adhesion performance is deteriorated with respect to the printing medium, and the problem as described above tends to arise, depending on the type of the selected polymerization initiator.

Additionally, even when the hardness is obtained, for example, the adhesion performance is not obtained depending on the type of the additive. It is difficult to obtain a photocation-curable ink which has both of the characteristics.

Japanese Patent Application Laid-open No. 2003-261817 intends to improve the adhesion performance by containing an amine compound. However, it is not affirmed that the hardness is sufficient.

### SUMMARY OF THE INVENTION

An object of the present invention is to improve both of the adhesion performance and the hardness for the photocation-curable ink as described above irrelevant to the type of the photopolymerization initiator.

Another object of the present invention is to provide a blending which makes it possible to carry out all methods in relation to the method for applying such a photocation-curable ink, for the following reason. That is, any ink, which is curable by the light, is cured in a time-dependent manner, for example, even by the ordinary sunlight and the electric light. Therefore, it is required that such an ink should be carefully dealt with, which should be adapted to all types of the applying or coating method.

In order to achieve the object as described above, according to a first aspect of the present invention, there is provided a photocation-curable ink which is curable by an active energy beam, the photocation-curable ink including a photocation-curable resin; a photopolymerization initiator; and a 2,2,6,6-tetramethylpiperidine 1-oxyl free radical; wherein molar concentration of the 2,2,6,6-tetramethylpiperidine 1-oxyl free radical in the ink is 19.6 mM to 39.2 mM.

According to a second aspect of the present invention, there is provided a photocation-curable ink which is curable by an active energy beam, the photocation-curable ink including a photocation-curable resin; a photopolymerization initiator; and a compound including a 2,2,6,6-tetramethylpiperidine 1-oxyl free radical structure; wherein molar concentration of the 2,2,6,6-tetramethylpiperidine 1-oxyl free radical structure in the ink is 19.6 mM to 39.2 mM.

According to a third aspect of the present invention, there is provided an ink-jet recording method including discharging the photocation-curable ink according to the first aspect or the second aspect of the present invention toward a printing medium; and curing the photocation-curable ink by radiating the active energy beam onto the discharged photocation-curable ink.

The photocation-curable of the present invention uses the 2,2,6,6-tetramethylpiperidine 1-oxyl free radical or the compound including the 2,2,6,6-tetramethylpiperidine 1-oxyl free radical structure as the additive in order to improve the adhesion performance with respect to the printing medium. Therefore, it is possible to obtain the photocation-curable ink in which the hardness of the ink coating film is high and the adhesion performance is high with respect to the printing medium,

### BRIEF DESCRIPTION OF THE DRAWINGS

FIG. 1 schematically shows an ink-jet recording apparatus for applying the photocation-curable ink of the present invention to a printing medium.

FIG. 2 schematically shows an ultraviolet radiation apparatus for curing the photocation-curable ink of the present invention applied onto the recording medium.

### DESCRIPTION OF THE PREFERRED EMBODIMENTS

The photocation-curable ink according to the present invention will be explained below.

The photocation-curable ink of the present invention contains the 2,2,6,6-tetramethylpiperidine 1-oxyl free radical or the compound including the 2,2,6,6-tetramethylpiperidine 1-oxyl free radical structure. The compound as described above is a type of the substance referred to as “hindered amine” (Hindered Amine Light Stabilizer: HALS). It is hitherto known that such a compound is usable as the photostabilizer and the antioxidant. Such a compound has been used for a way of use to avoid the deterioration of the physical property of the resin and the deterioration including, for example, the defective appearance such as the yellowing. The present inventors have found out the fact that the 2,2,6,6-tetramethylpiperidine 1-oxyl free radical or the compound including the 2,2,6,6-tetramethylpiperidine 1-oxyl free radical structure has an effect which is different in quality from the effect obtained in the conventional way of use of hindered amine. When the compound is contained in the photocation-curable ink which is curable by being irradiated with the active energy beam, the adhesion performance with respect to the printing medium is improved without lowering the hardness of the ink coating film. The reason thereof is postulated as follows. Namely, the photocation-curable ink forms an ink coating film by polymerization of the photocation-curable resin contained in the ink. When the polymerization rate is lowered in a latter stage (later stage) of the cationic polymerization reaction, the 2,2,6,6-tetramethylpiperidine 1-oxyl free radical structure bonds to growing ends of the resin, thereby mitigating (relaxing) the polymerization reaction. As a result, the contraction stress of the ink coating film is lowered and thus the adhesion performance of the ink coating film to the recording medium is improved.

The 2,2,6,6-tetramethylpiperidine 1-oxyl free radical of the present invention is the substance which is represented by the formula (1).

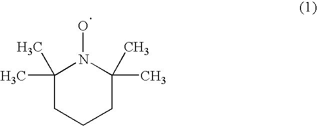

The compound including the 2,2,6,6-tetramethylpiperidine 1-oxyl free radical structure of the present invention is the compound which has the chemical structure shown in the formula (2) or (3) in the molecular structure. The compound of the present invention may have a plurality of the structures as described above in the molecule. The compound of the present invention is exemplified by irgastab UV-10 (produced by Ciba) by way of example.

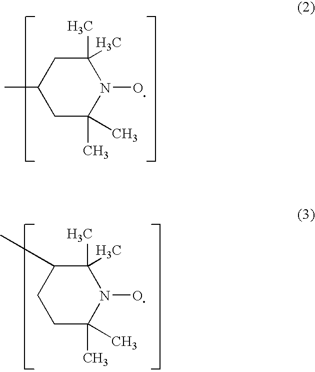

In order that the 2,2,6,6-tetramethylpiperidine 1-oxyl free radical structure bonds to the growing ends of the resin at the latter stage of the cationic polymerization so as to lower the contraction stress of the ink coating film as described above, it is preferable that the molar concentration of the 2,2,6,6-tetramethylpiperidine 1-oxyl free radical structure in the ink is not less than 19.6 mM (mill moles per liter). On the other hand, if the 2,2,6,6-tetramethylpiperidine 1-oxyl free radical structure is contained in the ink in an excessively great amount, then the 2,2,6,6-tetramethylpiperidine 1-oxyl free radical structure bonds to the growing ends of the resin at an initial (earlier) stage of the polymerization reaction, which in turn lowers the hardness of the ink coating film. For this reason, the molar concentration of the 2,2,6,6-tetramethylpiperidine 1-oxyl free radical structure in the ink is preferably not more than 39.2 mM. Accordingly, it is preferable that the molar concentration of the 2,2,6,6-tetramethylpiperidine 1-oxyl free radical or the 2,2,6,6-tetramethylpiperidine 1-oxyl free radical structure in the ink is 19.6 mM to 39.2 mM.

The photocation-curable ink of the present invention also contains the photocation-curable resin and the photopolymerization initiator.

The photocation-curable resin is the substance which is contained together with the photopolymerization initiator and which is cured by causing the polymerization reaction and/or the cross-linking reaction by being exposed with the active energy beam having a predetermined wavelength. The photocation-curable resin may include, for example, epoxy compounds, oxetane compounds, oxolane compounds, cyclic acetal compounds, cyclic lactone compounds, thiirane compounds, thiethane compounds, vinyl ether compounds, spiro ortho ester compounds as reaction products of epoxy compound and lactone, ethylenic unsaturated compounds, and cyclic thioether compounds.

The epoxy compound usable as the photocation-curable resin may include, for example, aliphatic epoxy compounds and alicyclic epoxy compounds.

The aliphatic epoxy compound may include, for example, bisphenol A type epoxy compounds, bisphenol F type epoxy compounds, alkylphenol novolak type epoxy compounds such as phenol novolak type epoxy compounds, cresol novolak type epoxy compounds, and p-tert-butylphenol novolak type epoxy compounds, hydrogenated bisphenol A type epoxy compounds, bisphenol A alkylene oxide diglycidyl ether, bisphenol F alkylene oxide diglycidyl ether, hydrogenated bisphenol A alkylene oxide diglycidyl ether, tetrabromobisphenol A type epoxy compounds, ethylene glycol diglycidyl ether, propylene glycol diglycidyl ether, neopentyl glycol diglycidyl ether, butanediol diglycidyl ether, hexanediol diglycidyl ether, cyclohexane dimethanol diglycidyl ether, polyethylene glycol diglycidyl ether, polypropylene glycol diglycidyl ether, trimethylolpropane diglycidyl ether, trimethylolpropane triglycidyl ether, pentaerythritol triglycidyl ether, pentaerythritol tetraglycidyl ether, sorbitol heptaglycidyl ether, sorbitol hexaglycidyl ether, resorcin diglycidyl ether, dicyclopentadiene/phenol addition type glycidyl ether, methylenebis(2,7-dihydroxynaphthalene) tetraglycidyl ether, 1,6-dihydroxynaphthalene diglycidyl ether, and 1,5-dihydroxynaphthalene diglycidyl ether.

The alicyclic epoxy compound includes, for example, multifunctional alicyclic epoxy compounds such as 3,4-epoxycyclohexylmethyl-3,4-epoxycyclohexane carboxylate (for example, Celloxide 2021P, produced by Daicel Chemical Industries, Ltd.), epoxide of ester of tetrahydrophthalic acid and tetrahydrobenzyl alcohol and ε-caprolactone adduct thereof (for example, Epolead GT301, GT401, produced by Daicel Chemical Industries, Ltd.), and 1,2-epoxy-4-(2-oxylanyl)cyclohexene adduct of 2,2-bis(hydroxymethyl)-1-butanol (for example, EWE 3150, produced by Daicel Chemical Industries, Ltd.); and monofunctional alicyclic epoxy compounds such as 4-vinylepoxycyclohexane (for example, Celloxide 2000, produced by Daicel Chemical Industries, Ltd.).

The oxetane compound to be used in the present invention refers to compounds of four-membered ethers. The oxetane compound is not specifically limited provided that the compound has at least one oxetane ring in the molecule. Specified examples of the compound having one oxetane ring include, for example, 3-ethyl-3-hydroxymethyloxetane (for example, Aron Oxetane OXT-101, produced by Toagosei Co., Ltd.), 3-(meta)allyloxymethyl-3-ethyloxetane, 3-ethyl-3-(cyclohexyloxy)methyloxetane (for example, Aron Oxetane OXT-213, produced by Toagosei Co., Ltd.), 3-ethyl-3-(2-ethylcyclohexyloxymethyl)oxetane (for example, Aron Oxetane OXT-212, produced by Toagosei Co., Ltd.), (3-ethyl-3-oxetanylmethoxy)methylbenzene, 3-ethyl-3-(phenoxymethyl)oxetane (for example, Aron Oxetane OXT-211, produced by Toagosei Co., Ltd.), 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, isobomyloxyethyl(3-ethyl-3-oxetanylmethyl)ether, isobomyl(3-ethyl-3-oxetanylmethyl)ether, 2-ethylhexyl(3-ethyl-3-oxetanylmethyl)ether, ethyldiethylene glycol(3-ethyl-3-oxetanylmethyl)ether, dicyclopentadiene(3-ethyl-3-oxetanylmethyl)ether, dicyclopentenyloxyethyl(3-ethyl-3-oxetanylmethyl)ether, dicyclopentenyl(3-ethyl-3-oxetanylmethyl)ether, tetrahydrofurfuryl(3-ethyl-3-oxetanylmethyl)ether, tetrabromophenyl(3-ethyl-3-oxetanylmethyl)ether, 2-tetrabromophenoxyethyl(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, 2-hydroxyethyl(3-ethyl-3-oxetanylmethyl)ether, 2-hydroxypropyl(3-ethyl-3-oxetanylmethyl)ether, butoxyethyl(3-ethyl-3-oxetanylmethyl)ether, pentachlorophenyl(3-ethyl-3-oxetanylmethyl)ether, pentabromophenyl(3-ethyl-3-oxetanylmethyl)ether, and bornyl(3-ethyl-3-oxetanylmethyl)ether. Specified examples of the compound having two or more oxetane rings include, for example, 3,7-bis(3-oxetanyl)-5-oxa-nonane, 3,3′-(1,3-(2-methylenyl)propanediylbis(oxymethylene))bis-(3-ethyloxetane), bis[1-ethyl(3-oxetanyl)]methyl ether, 1,4-bis[(3-ethyl-3-oxetanylmethoxy)methyl]benzene (for example, Aron Oxetane OXT-121, produced by Toagosei Co., Ltd.), 3-ethyl-3-{[(3-ethyloxetanyl)methoxy]methyl}oxetane (for example, Axon Oxetane OXT-221, produced by Toagosei Co., Ltd.), 1,3-bis[(3-ethyloxetane-3-yl)methoxy]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenylbis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyldimethylene(3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone modified dipentaerythritol hexakis(3-ethyl-3-oxetanylmethyl)ether, caprolactone modified dipentaerythritol pentakis(3-ethyl-3-oxetanylmethyl)ether, ditrimethylolpropane tetrakis(3-ethyl-3-oxetanylmethyl)ether, EO modified bisphenol A bis(3-ethyl-3-oxetanylmethyl)ether, PO modified bisphenol A bis(3-ethyl-3-oxetanylmethyl)ether, EO modified hydrogenated bisphenol A bis(3-ethyl-3-oxetanylmethyl)ether, PO modified hydrogenated bisphenol A bis(3-ethyl-3-oxetanylmethyl)ether, EO modified bisphenol F bis(3-ethyl-3-oxetanylmethyl)ether, oxetanyl silsesquioxane, oxetanyl silicate, and phenol novolak oxetane.

Other compounds, which are usable as the photocation-curable resin, may be exemplified, for example, by oxolane compounds such as tetrahydrofuran and 2,3-dimethyltetrahydrofuran; cyclic acetal compounds such as trioxane, 1,3-dioxolane, and 1,3,6-trioxane cyclooctane; cyclic lactone compounds such as β-propiolactone and ε-caprolactone; thiirane compounds such as ethylene sulfide, 1,2-propylene sulfide, and thioepichlorohydrin; thiethane compounds such as 3,3-dimethylthiethane; vinyl ether compounds such as ethylene glycol divinyl ether, triethylene glycol divinyl ether, trimethylolpropane trivinyl ether, triethylene glycol monobutyl ether, cyclohexanedimethanol divinyl ether, hydroxybutyl vinyl ether, dodecyl vinyl ether, propenyl ether propylene carbonate, methyl vinyl ether, ethyl vinyl ether, propyl vinyl ether, isobutyl vinyl ether, ethylene glycol monovinyl ether, diethylene glycol divinyl ether, butanediol divinyl ether, hexanediol divinyl ether, cyclohexane dimethanol monovinyl ether, cyclohexyl vinyl ether, 2-chloroethyl vinyl ether, 2-hydroxyethyl vinyl ether, diethylene glycol divinyl ether, 2,2-bis(4-vinyloxyethoxyphenyl)propane, and 1,4-bis(2-vinyloxyethoxy)benzene, specifically RAPT-CURE-DVE-3, RAPT-CURE CHVE, RAPT-CURE HBVE, RAPT-CURE RECP, and RAPT-CURE DDVE (produced by ISP), VECTOMER 4010 (produced by AlliedSignal), M-VE, E-VE, P-VE, iB-VE, EG-MVE, DGE-DVE, BD-DVE, HD-DVE, CHDM-DVE, and CH-VE (produced by BASF), and CEVE, HEVE, DEG-DVE, TEG-DVE, PBA-DEVE, and HQ-DEVE (produced by Nisso Maruzen Chemical); spiroorthoester compounds obtained by the reaction between epoxy compound and lactone; ethylenic unsaturated compounds such as vinylcyclohexane, isobutylene, and polybutadiene; and cyclic thioether compounds such as tetrahydrothiophene.

One species of the photocation-curable resin as exemplified above may be used singly, if necessary. Alternatively, two or more species of the photocation-curable resin as exemplified above may be used in combination, if necessary.

As the amount of addition of the photocation-curable resin of the present invention is greater, the post processing step such as heating for volatilization of solvent, natural drying, etc. and the environmental burden become smaller. In view of this, the amount of addition of the photocation-curable resin of the present invention is preferably 50 to 98% by weight and more preferably 90 to 98% by weight.

The photopolymerization initiator to be used in the present invention refers to the compound which is capable of releasing or liberating the substance to start the cationic polymerization by being irradiated or radiated with the active energy beam. The photopolymerization initiator is especially preferably an onium salt in which the acid is produced by being irradiated with the light. Such a substance includes, for example, diazonium salts, iodonium salts, and sulfonium salts which are onium salts wherein cationic portions or moieties thereof are aromatic diazonium, aromatic iodonium, and aromatic sulfonium respectively, and anionic portions or moieties thereof are composed of, for example, BF₄⁻, PF₆⁻, SbF₆⁻, or [BX₄]⁻ provided that X represents the phenyl group substituted with at least two or more fluorine atoms or trifluoromethyl groups. More specified examples may include, for example, aryldiazonium salt of tetrafluoroboron, triarylsulfonium salt of hexafluorophosphorus, diaryliodonium salt of hexafluorophosphorus, triarylphosphonium salt of hexafluoroantimony, diaryliodonium salt of hexafluoroantimony, tri-4-methylphenylsulphonium salt of hexafluoroarsenic, tri-4-methylphenylsulphonium salt of tetrafluoroantimony, tetralds(pentafluorophenyl)borate triarylsulfonium salt, tetrakis(pentafluorophenyl)borate diaryliodonium salt, mixture of acetylacetone aluminum salt and ortho-nitrobenzyl silyl ether, phenylthiopyridium salt, and hexafluorophosphorus allene-iron complex. Specified examples of the onium salt include, for example, ADEKA Optomer SP-150, ADEKA Optomer SP-170 (produced by ADEKA), UVI-6992 (produced by Dow Chemical Company), CPI-100P, CPI-101A, CPI-200K, CPI-210S (produced by SAN-APRO Ltd.), TEPBI-S (produced by Nippon Shokubai Co., Ltd.), and Rhodorsil 2074 (produced by Rhodia). One species of them may be used singly, or two or more species of them may be used in combination. Among them, it is preferable to use the initiator of the sulfonium salt or the iodonium salt with which the cured film slightly suffers the coloring.

It is also possible to use a photosensitizer including, for example, benzophenone, benzoisopropyl ether, thioxanthone, anthracene, and derivatives of these compounds together with the photopolymerization initiator in combination. Specified examples thereof include, for example, 4,4′-bis(diethylamino)benwphenone, 2,4′-diethylthioxanthone, isopropylthioxanthone, 9,10-diethoxyanthracene, and 9,10-dibutoxyanthracene (for example, Anthracure UVS-1331 produced by Kawasaki Kasei Chemicals Ltd.). The content of the photocation polymerization initiator is preferably 0.1 to 20% by weight and more preferably 0,2 to 15% by weight. In view of the productivity, it is desirable that the initiator is not used in any excessive amount. If the initiator is used in any excessive amount, then the light beam transmittance is lowered, the curing of the film bottom portion is insufficient, and the corrosion is strengthened in some cases. If the amount of the initiator is too small, then the amount of the active cationic substance to be generated or produced by being irradiated with the active energy beam is insufficient, and any sufficient curing property or curing performance is not obtained in some cases.

The coloring agent may be added to the photocation-curable ink according to the present invention. Those usable as the coloring agent include pigments and dyes. One type of the pigment or the dye may be used, or a plurality of types of the pigments or the dyes may be used simultaneously. Further, the pigment or pigments and the dye or dyes may be used simultaneously. Those usable as the pigment include organic pigments such as monoazo pigments, disazo pigments, azo lake pigments, quinacridone pigments, perylene pigments, anthrapyrimidine pigments, isoindolinone pigments, threne pigments, phthalocyanine pigments and the like, and inorganic pigments such as carbon black, chrome yellow, Bengala, titanium oxide, molybdenum red, cadmium red, cobalt blue, chrome green and the like. Those usable as the dye include dyes such as xanthen dyes, coumarin dyes, merocyanine dyes, carbocyanine dyes, stylyl dyes, thiadine dyes, adine dyes, methine dyes, oxadine dyes, phenylmethane dyes, cyanine dyes, azo dyes, anthraquinone dyes, pyrazoline dyes, stilbene dyes, quinoline dyes, leuco dyes and the like.

The method for applying the photocation-curable ink of the present invention onto the printing medium is not specifically limited. It is possible to make the selection from known applying or coating methods including, for example, the ink-jet, the spin coat, the bar coat, and the spray coating, depending on the type of the printing medium.

The active energy beam, which is usable to cure the photocation-curable ink of the present invention, may be those which decompose the photopolymerization initiator to generate or produce the proton or the carbonium ion (carbocation). The active energy beam includes the electromagnetic wave such as the ultraviolet light, the X-ray, the gamma-ray and the like. In particular, it is preferable to use the ultraviolet light-curable ink in view of, for example, the wavelength absorption performance of the photopolymerization initiator, and the versatility of the resin to be used and the radiation apparatus. In this case, it is possible to preferably use, for example, the high voltage mercury lamp, the metal halide lamp, and the xenon lamp as the light source.

The photocation-curable ink of the present invention is blended by sufficiently agitating the 2,2,6,6-tetramethylpiperidine 1-oxyl free radical or the compound including the 2,2,6,6-tetramethylpiperidine 1-oxyl free radical in the partial structure, the photocation-curable resin, the photopolymerization initiator, and optionally the coloring agent and other additives. When the pigment is used as the coloring agent, the pigment is distinctly dispersed in a dispersion medium (to use the photocation-curable resin), for example, by means of a ball mill or a bead mill to prepare a mill base. The mill base is mixed with the other substances, followed by being agitated to obtain the photocation-curable ink. It is desirable that the prepared ink is filtrated through a filter of about 2 μm. In the operation as described above, it is necessary that the apparatus to be used should be placed in an environment such as a dark room or the like in which the active energy beam is absent, in order to prevent the ink from being cured during the operation.

It is enough that the printing medium to be used in the present invention is any medium capable of being generally used for the printing. The printing medium includes, for example, the paper, the resin such as polyethylene terephthalate (PET), the metal such as iron and aluminum, and the fabric or cloth such as T-shirt.

### Examples

Examples of the present invention will be explained below. However, the present invention is not limited to Examples.

### Preparation of Ink

Respective components shown in Tables 1, 2, and 3 were collected in a vessel at predetermined ratios in a dark room, followed by being agitated and then filtrated through a Polyflon filter having a pore size of 2 μm to prepare inks of Examples and Comparative Examples respectively. Table 4 shows a list of manufactures of respective substances shown in Tables 1, 2, and 3. The oxetane compound (OXT-213), the carbon black pigment, and the pigment dispersing agent (Solsperse) were collected for the inks at the following ratios, and then the pigment was dispersed by means of a bead mill. After that, the respective materials were collected in the vessel to give the ratios shown in Tables 1 and 2, and the agitation was performed.

Oxetane compound (OXT-213): 60% by weight

Carbon black pigment: 25% by weight

Pigment dispersing agent (Solsperse):15% by weight

The compound irgastab UV-10 was used as an additive for improving the adhesion performance of the ink with respect to the printing medium for each of the photocation-curable inks of Examples 1 to 8. The irgastab UV-10 is a compound which includes the 2,2,6,6-tetramethylpiperidine 1-oxyl free radical structure. The molar concentration of the 2,2,6,6-tetramethylpiperidine 1-oxyl free radical structure in each of the inks of Examples 1, 3, 5 and 7 is 39.2 mM. The molar concentration of the 2,2,6,6-tetramethylpiperidine 1-oxyl free radical structure in each of the inks of Examples 2, 4, 6 and 8 is 19.2 mM. The 2,2,6,6-tetramethylpiperidine 1-oxyl free radical was used as the additive for improving the adhesion performance in each of Examples 9 and 10. The molar concentrations of the 2,2,6,6-tetramethylpiperidine 1-oxyl free radical in the inks of Examples 9 and 10 are 39.2 mM and 19.6 mM respectively.

On the other hand, in Comparative Examples 1 to 4, any additive for improving the adhesion performance was not added to the inks each of which was based on the use of the same photopolymerization initiator as that used in each of Examples 1 to 8. In Comparative Examples 5 to 8, ADEKA STUB LA-77Y was added in the inks each of which was based on the use of the same photopolymerization initiator as that used in each of Examples 1 to 8. ADEKA STUB LA-77Y is a hindered amine which does not include the 2,2,6,6-tetramethylpiperidine 1-oxyl free radical structure.

In Comparative Example 9, any additive for improving the adhesion performance was not added to the ink which was based on the use of the same photopolymerization initiator as that used in each of Examples 9 and 10. In Comparative Examples 10 and 11, 2,2,6,6-tetramethylpiperidine as one of hindered amines was added in the inks each of which was based on the use of the same photopolymerization initiator as that used in each of Examples 9 and 10. The compound 2,2,6,6-tetramethylpiperidine has the same structure as that of the 2,2,6,6-tetramethylpiperidine 1-oxyl free radical except that the compound 2,2,6,6-tetramethylpiperidine does not have the free radical.

Inks of Comparative Examples 12 and 13 are inks in each of which the photopolymerization initiator and the additive same as those used in Examples 7 and 8. The molar concentrations of the 2,2,6,6-tetramethylpiperidine 1-oxyl free radical structure in the inks of Comparative Examples 12 and 13 are 3.92 mM and 58.8 mM respectively.

TABLE 1

| | | Example | | | | | | | |
|---|---|---|---|---|---|---|---|---|---|
| | | 1 | 2 | 3 | 4 | 5 | 6 | 7 | 8 |
| Additive | irgastab UV-10 | 1 | 0.5 | 1 | 0.5 | 1 | 0.5 | 1 | 0.5 |
| | ADEKA STUB | | | | | | | | |
| | LA-77Y | | | | | | | | |
| | TEMPO | | | | | | | | |
| | TEMP | | | | | | | | |
| Photocation- | Celloxide 2021P | 50 | 50 | 50 | 50 | 50 | 50 | 50 | 50 |
| curable resin | OXT-213 | 20 | 20 | 20 | 20 | 20 | 20 | 20 | 20 |
| | Celloxide 2000 | 30 | 30 | 30 | 30 | 30 | 30 | 30 | 30 |
| Pigment | Carbon black | 2 | 2 | 2 | 2 | 2 | 2 | 2 | 2 |
| Pigment | Solsperse | 1.2 | 1.2 | 1.2 | 1.2 | 1.2 | 1.2 | 1.2 | 1.2 |
| dispersing agent | | | | | | | | | |
| Photopolymerization | Rhodorsil 2074 | 3 | 3 | | | | | | |
| initiator | CPI 100P | | | 8 | 8 | | | | |
| | CPI 101A | | | | | 6 | 6 | | |
| | CPI 200K | | | | | | | 6 | 6 |
| | CPI 210S | | | | | | | | |
| Sensitizer | Anthracure UVS- | 2 | 2 | 2 | 2 | 2 | 2 | 2 | 2 |
| | 1331 | | | | | | | | |

| | | | | | | | | |
|---|---|---|---|---|---|---|---|---|
| Hardness | ++ | ++ | + | + | ++ | ++ | + | + |
| Adhesion performance | + | + | + | + | + | + | + | + |

TEMPO: 2,2,6,6-tetramethylpiperidine 1-oxyl free radical
TEMP: 2,2,6,6-tetramethylpiperidine

TABLE 2

| | | Comparative Example | | | | | | | |
|---|---|---|---|---|---|---|---|---|---|
| | | 1 | 2 | 3 | 4 | 5 | 6 | 7 | 8 |
| Additive | irgastab UV-10 | | | | | | | | |
| | ADEKA STUB | | | | | 1 | 1 | 1 | 1 |
| | LA-77Y | | | | | | | | |
| | TEMPO | | | | | | | | |
| | TEMP | | | | | | | | |
| Photocation- | Celloxide 2021P | 50 | 50 | 50 | 50 | 50 | 50 | 50 | 50 |
| curable resin | OXT-213 | 20 | 20 | 20 | 20 | 20 | 20 | 20 | 20 |
| | Celloxide 2000 | 30 | 30 | 30 | 30 | 30 | 30 | 30 | 30 |
| Pigment | Carbon black | 2 | 2 | 2 | 2 | 2 | 2 | 2 | 2 |
| Pigment | Solsperse | 1.2 | 1.2 | 1.2 | 1.2 | 1.2 | 1.2 | 1.2 | 1.2 |
| dispersing agent | | | | | | | | | |
| Photopolymerization | Rhodorsil 2074 | 3 | | | | 3 | | | |
| initiator | CPI 100P | | 8 | | | | 8 | | |
| | CPI 101A | | | 6 | | | | 6 | |
| | CPI 200K | | | | 6 | | | | 6 |
| | CPI 210S | | | | | | | | |
| Sensitizer | Anthracure UVS- | 2 | 2 | 2 | 2 | 2 | 2 | 2 | 2 |
| | 1331 | | | | | | | | |

| | | | | | |
|---|---|---|---|---|---|
| Hardness | ++ | + | ++ | + | not cured |
| Adhesion performance | − | − | − | − | |

TEMPO: 2,2,6,6-tetramethylpiperidine 1-oxyl free radical
TEMP: 2,2,6,6-tetramethylpiperidine

TABLE 3

| | | Example | | Comparative Example | | | | |
|---|---|---|---|---|---|---|---|---|
| | | 9 | 10 | 9 | 10 | 11 | 12 | 13 |
| Additive | irgastab UV- | | | | | | 0.1 | 1.5 |
| | 10 | | | | | | | |
| | ADEKA | | | | | | | |
| | STUB LA- | | | | | | | |
| | 77Y | | | | | | | |
| | TEMPO | 0.61 | 0.31 | | | | | |
| | TEMP | | | | 0.56 | 0.28 | | |
| Photocation- | Celloxide | 50 | 50 | 50 | 50 | 50 | 50 | 50 |
| curable | 2021P | | | | | | | |
| resin | OXT-213 | 20 | 20 | 20 | 20 | 20 | 20 | 20 |
| | Celloxide | 30 | 30 | 30 | 30 | 30 | 30 | 30 |
| | 2000 | | | | | | | |
| Pigment | Carbon | 2 | 2 | 2 | 2 | 2 | 2 | 2 |
| | black | | | | | | | |
| Pigment | Solsperse | 1.2 | 1.2 | 1.2 | 1.2 | 1.2 | 1.2 | 1.2 |
| dispersing | | | | | | | | |
| agent | | | | | | | | |
| Photopolymerization | Rhodorsil 2074 | | | | | | | |
| initiator | | | | | | | | |
| | CPI 100P | | | | | | | |
| | CPI 101A | | | | | | | |
| | CPI 200K | | | | | | 6 | 6 |
| | CPI 210S | 3 | 3 | 3 | 3 | 3 | | |
| Sensitizer | Anthracure | 2 | 2 | 2 | 2 | 2 | 2 | 2 |
| | UVS-1331 | | | | | | | |

| | | | | | | | |
|---|---|---|---|---|---|---|---|
| Hardness | ++ | ++ | ++ | − | − | + | − |
| Adhesion performance | + | + | − | + | ± | − | + |

TEMPO: 2,2,6,6-tetramethylpiperidine 1-oxyl free radical
TEMP: 2,2,6,6-tetramethylpiperidine

TABLE 4

| Type of compound | Name | Manufacturer |
|---|---|---|
| Additive | irgastab UV-10 | Ciba |
| | ADEKA STUB LA-77Y | ADEKA |
| | TEMPO | Tokyo Kasei |
| | | Kogyo Co., Ltd. |
| | TEMP | Acros |
| Photocation-curable resin | Celloxide 2021P | Daicel Chemical |
| | | Industries, Ltd. |
| | OXT-213 | Toagosei Co., Ltd. |
| | Celloxide 2000 | Daicel Chemical |
| | | Industries, Ltd. |
| Pigment | Carbon black | — |
| Pigment dispersing agent | Solsperse | Lubrizol |
| Photopolymerization | Rhodorsil 2074 | Rhodia |
| initiator | CPI 100P | SAN-APRO Ltd. |
| | CPI 101A | SAN-APRO Ltd. |
| | CPI 200K | SAN-APRO Ltd. |
| | CPI 210S | SAN-APRO Ltd. |
| Sensitizer | Anthracure UVS-1331 | Kawasaki Kasei |
| | | Chemicals Ltd. |

TEMPO: 2,2,6,6-tetramethylpiperidine 1-oxyl free radical
TEMP: 2,2,6,6-tetramethylpiperidine

### Formation of Ink Coating Film

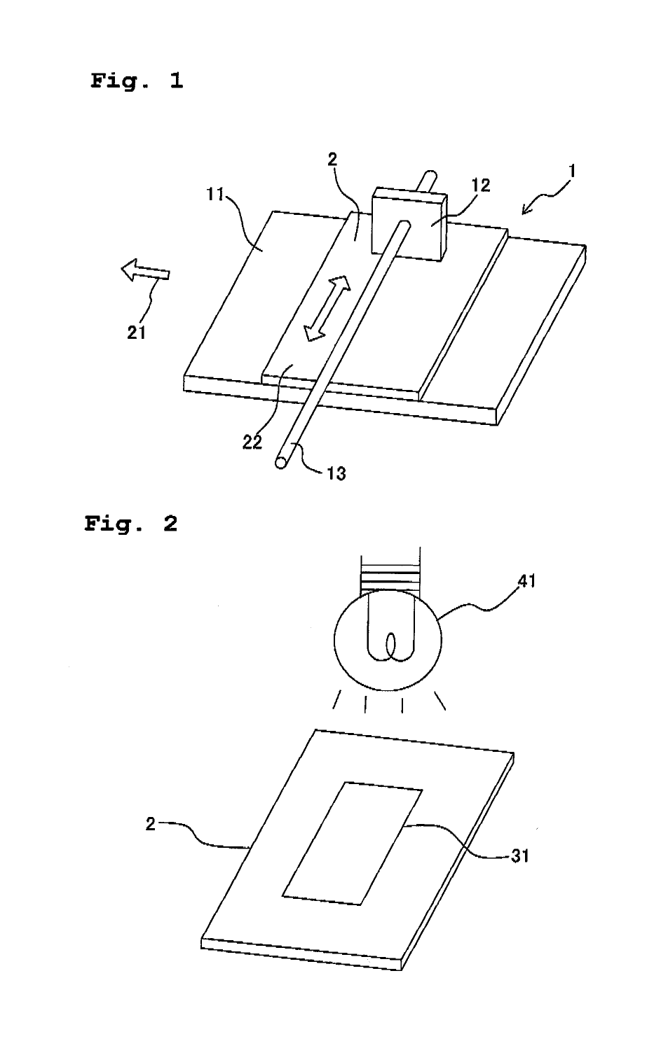

The inks, which were prepared to have the compositions shown in Tables 1, 2, and 3, were used to form coating films on the printing medium by means of an ink-jet recording apparatus 1 based on the use of a piezo-type ink-jet head as shown in FIG. 1. In this embodiment, a PET film was used for the printing medium. The ink-jet recording apparatus 1 shown in FIG. 1 discharges the photocation-curable ink of the present invention from the ink-jet head 12 toward the printing medium 2 placed on a printing medium support base 11. During this process, the printing medium support base 11 is moved in the direction of the arrow 21 by means of an unillustrated motor unit. Further, the ink-jet head 12 performs the reciprocating movement in the directions of the arrow 22 on a slide rail 13 in accordance with the operation of, for example, the unillustrated motor unit. Accordingly, the coating film of the photocation-curable ink of the present invention can be formed at any arbitrary position on the surface of the printing medium 2.

### Curing of Ink Coating Film

The PET film, on which the coating film of the ink has been formed, is irradiated with the ultraviolet light, and thus the ink on the printing medium is cured. The curing method includes, for example, the irradiation with the ultraviolet light by means of an ultraviolet lamp 41 with respect to a range 31 in which the photocation-curable ink has been applied on the printing medium 2 as shown in FIG. 2. The irradiation was performed by using a metal halide lamp under a condition in which the peak illuminance was 150 mW/cm², and the totalized quantity of light was 600 mJ/cm².

### Evaluation

The printing medium, on which the ink coating film was formed, was evaluated in relation to the following items.

### Hardness

The hardness was evaluated by means of the pencil hardness test (JIS K5600-5-4).

++: Hardness was not less than 3H.

+: Hardness was H to 2H.

−: Hardness was not more than F.

### Adhesion Performance

The adhesion or adhesion performance was evaluated by means of the Cross Cut Test (JIS K5400).

+: All of 100 pieces were adhered.

±: At least one piece or more pieces was/were peeled off or exfoliated.

−: All of 100 pieces were peeled off or exfoliated.

The evaluation results obtained as described above are shown in Tables 1, 2, and 3. In the case of the photocation-curable inks of Examples 1 to 10, the adhesion performance was improved without deteriorating or lowering the hardness, as compared with Comparative Examples 1 to 4 and 9 in which no additive was contained. In Comparative Examples 5 to 8, the curing was not caused under the same condition as that of Examples.

In Comparative Examples 10 and 11, the hardness was lowered although the improvement in the adhesion performance was observed, as compared with Comparative Example 9 in which no additive was contained.

Further, in Comparative Example 12 in which the molar concentration of the 2,2,6,6-tetramethylpiperidine 1-oxyl free radical structure was lower than Examples 1 to 10, the evaluation of the adhesive performance of the ink coating film was inferior. On the other hand, in Comparative Example 13 in which the molar concentration of the 2,2,6,6-tetramethylpiperidine 1-oxyl free radical structure was higher than Examples 1 to 10, the evaluation of the hardness of the ink coating film was inferior.

According to the comparison between the evaluation results of Examples 1 to 10 and those of Comparative Examples 1 to 4 and 9, the following fact has been revealed. That is, when the 2,2,6,6-tetramethylpiperidine 1-oxyl free radical or the compound including the 2,2,6,6-tetramethylpiperidine 1-oxyl free radical structure is added to the photocation-curable ink, the adhesion performance with respect to the printing medium is improved without lowering the hardness of the ink coating film, as compared with when the 2,2,6,6-tetramethylpiperidine 1-oxyl free radical or the compound including the 2,2,6,6-tetramethylpiperidine 1-oxyl free radical structure is not added. Further, it has been revealed that this effect does not depend on the type of the photopolymerization initiator. Furthermore, it has been revealed, from the comparison between the evaluation results of Examples 1 to 10 and those of Comparative Examples 12 and 13, that the molar concentration of the 2,2,6,6-tetramethylpiperidine 1-oxyl free radical structure in the ink is preferably 19.6 mM to 39.2 mM.

According to the comparison between Examples 1 to 10 and Comparative Examples 5 to 8, 10 and 11, the following fact has been revealed. That is, the effect of the present invention, in which the adhesion performance is improved with respect to the printing medium without lowering the hardness of the ink coating film, is not any general characteristic of the hindered amine, but the effect is inherent in the 2,2,6,6-tetramethylpiperidine 1-oxyl free radical and the compound including the 2,2,6,6-tetramethylpiperidine 1-oxyl free radical structure. Further, it has been clarified that the free radical in the chemical structure contributes to the effect to improve the adhesion performance without lowering the hardness of the ink coating film.

The present invention has been specifically explained above with reference to Examples. However, the present invention is not limited thereto. In Examples described above, the pigment was used as the coloring agent. However, it is also possible to use the dye in place thereof. Alternatively, the pigment and the dye may be used simultaneously. Those other than those described above in Examples can be used for the ink-jet recording system, the ink-jet head, and the ink-jet recording apparatus. It is also allowable to adopt, for example, an ink-jet recording apparatus and a recording method as described in U.S. Pat. No. 6,866,376 which is incorporated hereinto by reference.

What is claimed is:

1. A photocation-curable ink which is curable by an active energy beam, the photocation-curable ink comprising:
a photocation-curable resin;
a photopolymerization initiator; and
a 2,2,6,6-tetramethylpiperidine 1-oxyl free radical;
wherein molar concentration of the 2,2,6,6-tetramethylpiperidine 1-oxyl free radical in the ink is 19.6 mM to 39.2 mM.

2. The photocation-curable ink according to claim 1, wherein the 2,2,6,6-tetramethylpiperidine 1-oxyl free radical is an additive which improves adhesion performance of the photocation-curable ink with respect to a printing medium.

3. The photocation-curable ink according to claim 1, further comprising a coloring agent which is a dye or a pigment.

4. The photocation-curable ink according to claim 1, wherein the photocation-curable resin includes a multifunctional alicyclic epoxy compound, a monofunctional alicyclic epoxy compound, and an oxetane compound.

5. An ink-jet recording method comprising:
discharging the photocation-curable ink as defined in claim 1 toward a printing medium; and
curing the photocation-curable ink by radiating the active energy beam onto the discharged photocation-curable

6. The ink-jet recording method according to claim 5, wherein the photocation-curable ink is discharged toward the recording medium by using an ink-jet head.

7. A photocation-curable ink which is curable by an active energy beam, the photocation-curable ink comprising:
a photocation-curable resin;
a photopolymerization initiator; and
a compound including a 2,2,6,6-tetramethylpiperidine 1-oxyl free radical structure; wherein molar concentration of the 2,2,6,6-tetramethylpiperidine 1-oxyl free radical structure in the ink is 19.6 mM to 39.2 mM.

8. The photocation-curable ink according to claim 7, wherein the compound is an additive which improves adhesion performance of the photocation-curable ink with respect to a printing medium.

9. The photocation-curable ink according to claim 7, further comprising a coloring agent which is a dye or a pigment.

10. The photocation-curable ink according to claim 7, wherein the photocation-curable resin includes a multifunctional alicyclic epoxy compound, a monofunctional alicyclic epoxy compound, and an oxetane compound.

11. An ink-jet recording method comprising;
discharging the photocation-curable ink as defined in claim 7 toward a printing medium; and
curing the photocation-curable ink by radiating the active energy beam onto the discharged photocation-curable ink.

12. The ink-jet recording method according to claim 11, wherein the photocation-curable ink is discharged toward the recording medium by using an ink-jet head.
